(19) United States
(12) Patent Application Publication
(10) Pub. No.: US 2012/0246035 A1
(43) Pub. Date: Sep. 27, 2012

(54) Computer software program and fashion styling tool

(75) Inventors: Kenisha Cross, San Diego, CA (US); Angelique Michelle, Sherman Oaks, CA (US)

(73) Assignee: Kenisha Cross, Sherman Oaks, CA (US)

(21) Appl. No.: 13/385,225

(22) Filed: Feb. 7, 2012

Related U.S. Application Data
(60) Provisional application No. 61/457,230, filed on Feb. 7, 2011.

(51) Int. Cl. G06Q 30/00

(52) U.S. Cl. 705/27.1

(57) ABSTRACT

A computer program product is provided for allowing users to share, edit, and purchase wardrobe items in connection with displaying and categorizing those items on a display.

### CLAIM OF PRIORITY UNDER 35 USC 119

The present application for patent claims priority to U.S. Provisional Application No. 61/457,230, entitled “Computer Software Program and Fashion Styling Tool,” filed on Feb. 7, 2012.

### BACKGROUND

Many hours can be spent conceptualizing various wardrobe combinations, e.g. “creating Looks.” Personal shoppers and/or image consultants performing this task may charge a client large fees in travel expenses. The process of creating Looks entails mixing and matching what looks good together. This may include the following: placing clothes on the floor for display; photographing those clothes as a complete Look with all its components; getting pictures developed; and organizing and filing all of the photographed Looks in a methodical order in a categorized album or book. The many steps involved in creating a so-called “Look Book” and a wardrobe filing system takes countless hours and numerous days to complete. A need exists to realize this process in a more time efficient, more convenient, and more productive manner using a computer.

### BRIEF DESCRIPTION OF THE DRAWINGS

FIG. 1 illustrates a sample screenshot showing various Looks labeled L-0001 through L-0006.

FIG. 2 illustrates a screenshot showing a wardrobe organized according to garment type.

FIG. 3 is a drawing representative of a screenshot showing a 3-D image of a model wearing a selected Look.

### DETAILED DESCRIPTION

A program and system for cataloging and virtually displaying selected combinations of clothing for an existing or prospective wardrobe is provided through a computer software program and fashion styling tool. The software program and fashion styling tool may be accomplished as a Web application. In one preferred embodiment, this tool is provided as a cloud application for delivery over a cloud application service. Typical cloud computing providers deliver software applications online that are accessed using a Web browser while the software and data are stored on servers. Clouds often appear as single points of access for consumers' computing needs. Sharing of data and applications may be accomplished using Microsoft SharePoint or similar application.

The computer software program and fashion styling tool as disclosed herein may provide a universal tool for individuals within the styling industry. For instance, it may provide a staple tool/program that stylists use to style their clients. It may also be a tool that educators use to teach fashion classes. Moreover it may provide a primary staple wardrobe organizer, planner, developer, and styling tool/program.

In one embodiment, the styling tool/program allows users to upload images of individual items within a selected wardrobe. The uploaded destination may, for instance, be a location in cloud storage. Once images of items are uploaded, users may organize and file wardrobe items according to preferred categories. In one embodiment, wardrobes may be categorized according to Looks, Designer, Color, Garment or other preferred user chosen schemes.

A Look may be defined as an outfit that is created with wardrobe items grouped together as a set. For instance, a Look may include a pants, top and sweater combination. Users may perform a number of tasks using Looks. These include filing Looks that are already created; viewing items within another's wardrobe uploaded to storage, provided permission is granted; receiving/supplying advise and assistance from/to another; sending image items, e.g., through the cloud or via email, from one's own uploaded wardrobe to another's; creating shopping lists; creating lists for packing for travel; providing closet editing; and printing Looks and images. This wardrobe tool/program may be used to benefit both males and females. It should be noted that the term “closet” as used herein refers to a collection of apparel items held by an entity. A collective wardrobe may also be termed as a “closet.” Additionally, “closet is used to refer to the organized portfolio of apparel items intended for use/display.

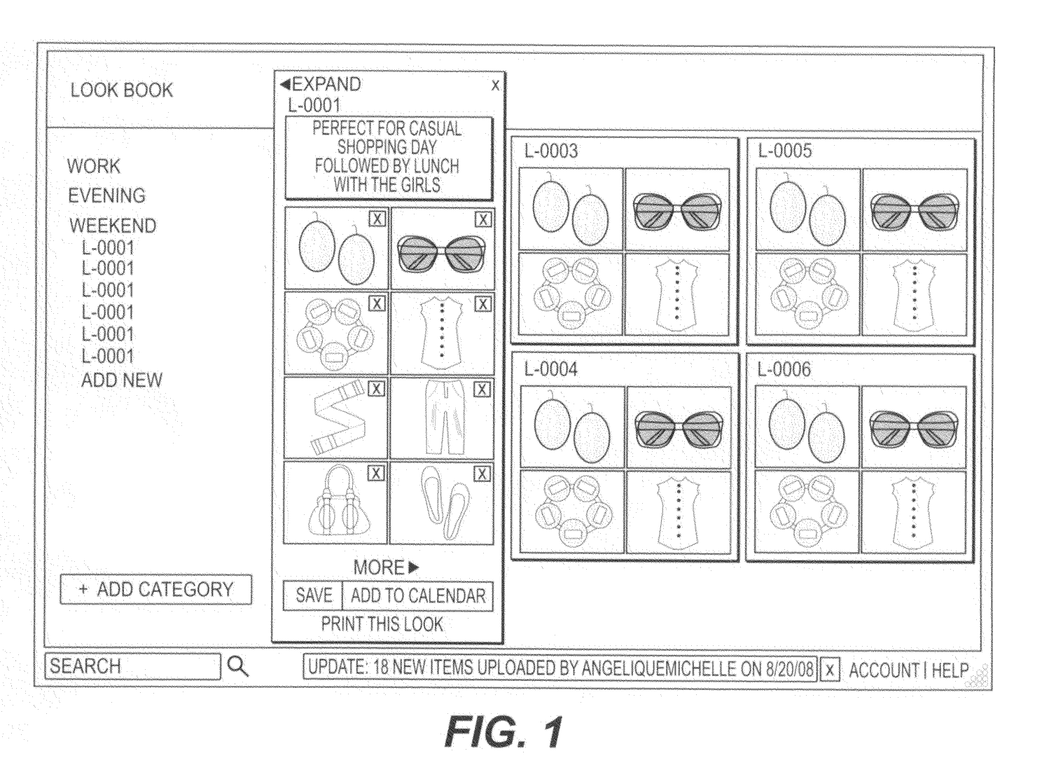

FIG. 1 illustrates a sample screenshot showing various Looks labeled L-0001 through L-0006. As shown, Look L-0001 also includes a description of the Looks intended purpose.

Wardrobe items may be organized according to a category of a specific Designer; a particular color; or a type of garment, e.g. coat, sweater, blouse, etc. Information stored per category may be used to supply statistics useful for data warehousing, particularly where the program/tool is accessed as a cloud application.

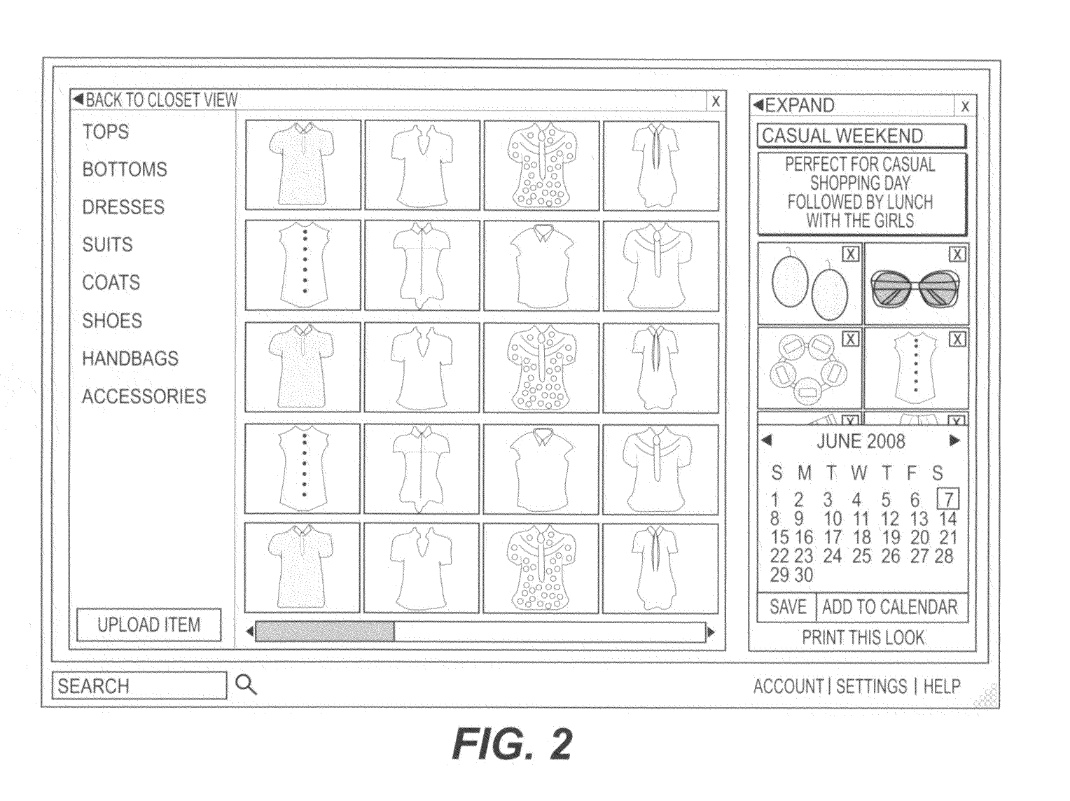

FIG. 2 illustrates a screenshot showing a wardrobe organized according to garment type. As shown in FIG. 2, a variety of tops occur in the screenshot. In addition to displaying items according to various categories, wardrobe items may be scheduled for use according to, for instance, Look categories. As shown in FIG. 2, Looks may be selected for wear in conjunction with a calendar event. For instance, a Look may be scheduled for use at a day or specific time of day in a calendar month. FIG. 2 illustrates a screen shot showing a selected Look scheduled for use on Jun. 7, 2008.

Creating and developing a computer program and system according to the foregoing may serve as a tool for performing personal shopping and image consulting. It enables a client to spend less money, stay better organized, and keep track of his or her created Looks. The program/tool may also implement a time keeping function to be used to monitor the amount of time that a consultant is spending on image consulting work, thereby providing a control to help prevent a client from being overcharged for such consultant work.

Users of the program/tool may be granted permission to view the wardrobe of another and to suggest purchase of items via the Internet (or other network) or exchange with items of other users. By enabling others to see one's wardrobe, for example, via a Web application, advice can be offered, for instance, on what to wear to work, special events, etc. A system that files and stores one's wardrobe and makes it available for viewing by others, such as friends can be extremely beneficial.

In connection with suggestions for purchase, an image of an item from a seller such as a garment seller may be uploaded over the Internet. Additionally, in one embodiment, purchases may occur in connection with using the program/tool for one's behalf or to benefit another.

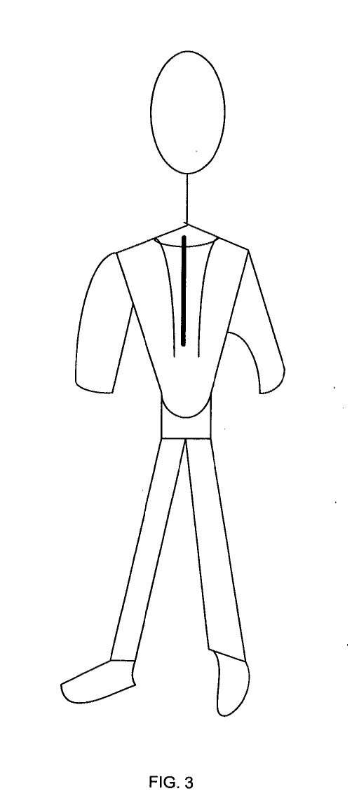

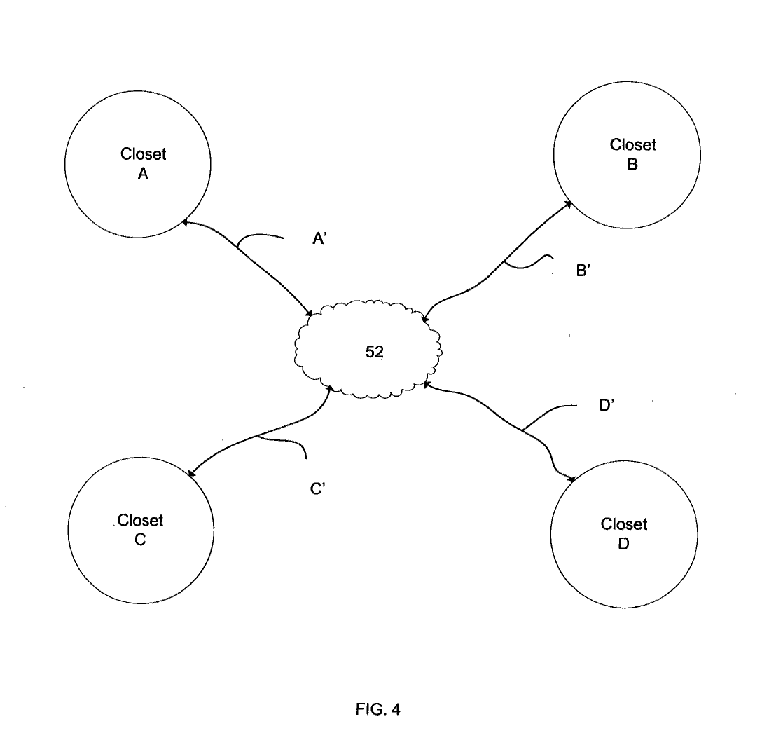

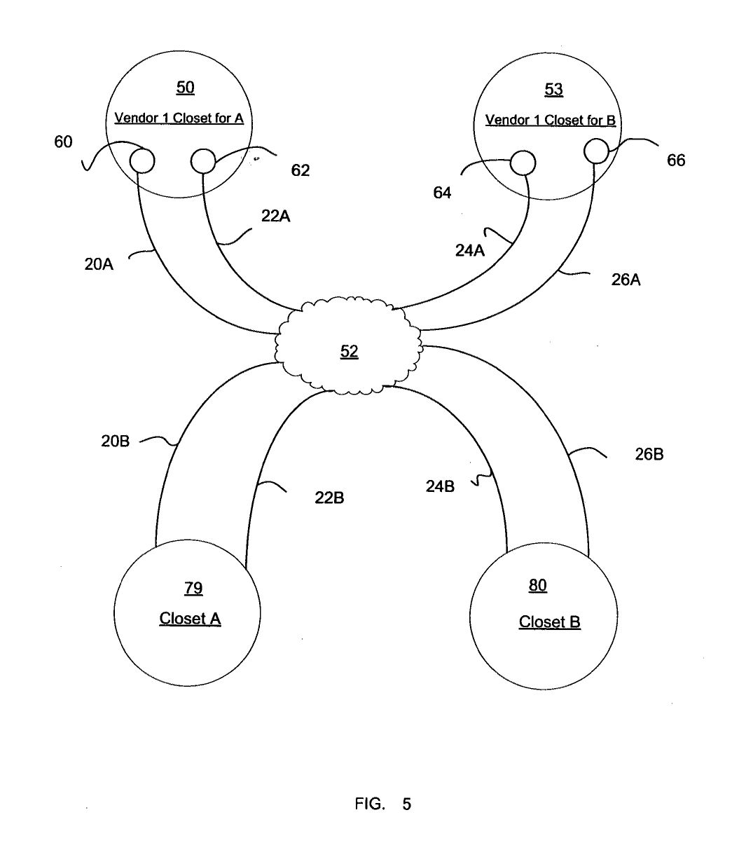

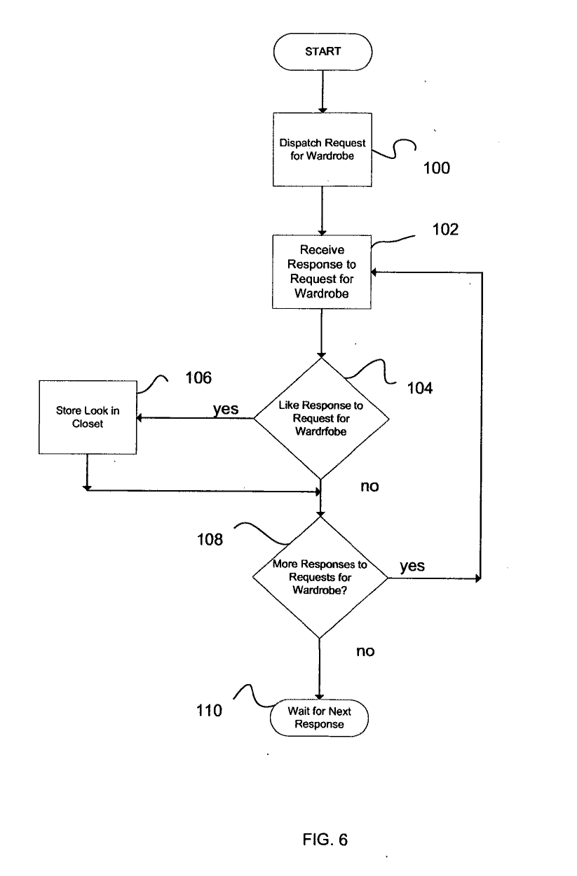

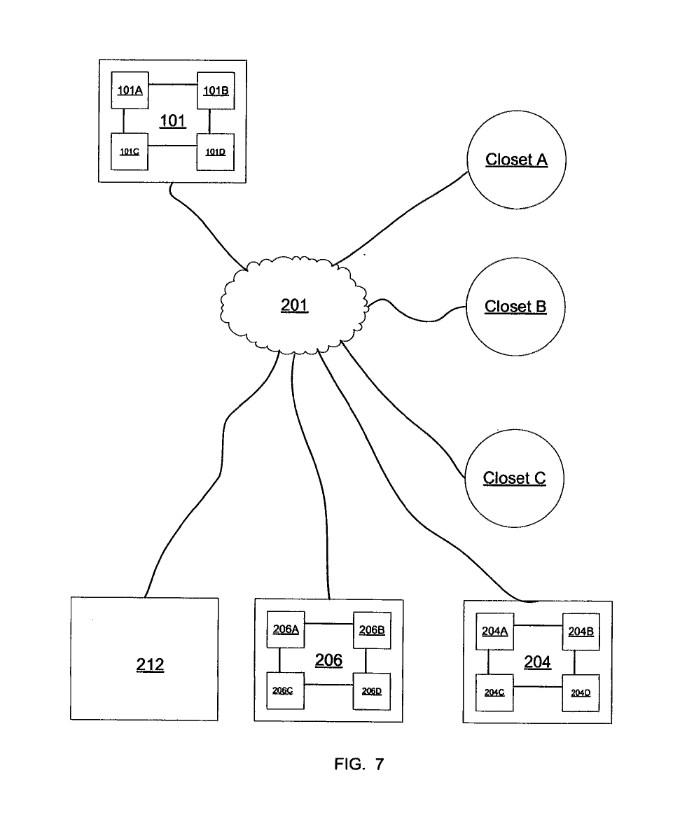

In another embodiment a three-dimensional image of a subject's profile is uploaded together with the subject's physical dimensions. The program/tool can be used to generate an image of the clothed subject including the garments chosen according to the Look. This may be accomplished through well known methods of virtual reality modeling accomplished in connection with the program/tool wherein a computer generated image of wardrobe items are modeled on an image of a subject according to the subject's scaled physical dimensions. FIG. 3 illustrates a screenshot showing a 3-D image of a model wearing a selected Look according to the foregoing described embodiment.

Access may be provided to part or all of a closet. This includes access to individual garments in closet as well as to access to individual Looks in a closet. In addition to viewing a closet, suggested items for purchase or trade may be placed into a closet for addition to a wardrobe pursuant to completion or augmentation of a Look. The suggestion may include pricing information; sizing information; material content; origin of manufacture; material content; origin of manufacture; designer information; and location for purchase information.

Users of the foregoing described program/tool may be organized into one or more groups, each group being referred to as a Closet Club. Members of the Closet Club may comprise members of a network capable of being in electronic communication with one another through a network. FIG. 4 is a diagram illustrating the connectivity among closets of Closet Club members through a network. Closets A, B, C and D joined by connections A′, B′, C′, and D′ respectively, to Network 52 may exchange information through Network 52 which represents the Internet and an intranet or other communication network. Closets information may be resident at one or more servers accessed trough a terminal such as a computer of mobile device. Alternatively or additionally, closet information may be resident locally on a computer or other storage medium. In one embodiment of the invention, a request for an article of clothing may be posted and dispatched to members of the Closet Club. The Closet Club members may include venders, friends, personal shopper. The request may be written and it may accompanied with a Look. For instance, the Look may include a dress and stockings and the request may pertain to shoes needed to complete the Look. More particularly, the request may include sizing information, color, pricing range, styling and as much detail as the requestor chooses to include.

Requests are delivered to specified members of the Closet Club appearing as a closet invitation in the closets of individual members. Vendors may have a closet with information/recommendations for possible purchase based upon the requests from fellow Closet Club members. Alternatively, the Looks may be gleaned from information pertaining to Closet Club members based on what may be learned through access to a member's closet. More specifically, with knowledge of a member's sizing and indicated preferences such as indicated price ranges, a closet with Looks and/or apparel may be designed for individual closet club members. A third party closet may be set up as a separate account by a Closet Club member for the benefit of another member. For instance, a vendor or stylist may set up one or more closets for each customer complete with Looks and individual apparel items. A timing function for billing time spent on a customer's closet may be implemented in any of the servers discussed herein or on any of the access devices discussed herein.

FIG. 5 is a diagram illustrating the concept of the 3^{rd} party Closet. Vendor 1 Closet for member A is represented by reference numeral 50 and Vender 1 Closet for member B is represented by reference numeral 53. Network 52 which represents the Internet an intranet or other communication network, serves to connect Vendor closets to respective intended recipients. Looks 60 and 62 from Vendor 1 Closet are intended for Closet Club member A. Path 20A from Vendor 1 Closet for A 50 charts the route of Look 60 to network 52. Path 20B charts the route from network 54 of Look 60 to the intended recipient, Closet A 79. Path 22A from Vendor 1 Closet for A 50 charts the route of Look 62 to network 54. Path 22B charts the route from network 52 of Look 62 to intended recipient Closet A 79.

Looks 64 and 66 from Vendor 1 Closet 52 are intended for Closet Club member B 80. Path 24A from Vendor 1 Closet for B 53 charts the route of Look 64 to network 52. Path 24B charts the route from network 52 of Look 64 to the intended recipient, Closet B 80. Path 26A from Vendor 1 Closet for B 53 charts the route of Look 66 to network 52. Path 26B charts the route from network 52 of Look 66 to the intended recipient, Closet B 80. Looks may be dispatched with purchase information or other data useful for the evaluation of the Look

Requests for Looks or apparel items may be deemed a Request for Wardrobe. The Request for Wardrobe may be dispatched to selected members of a Closet Club. Those selected members may include, for example, vendors and/or stylists. The request may contain a deadline date by which a garment or Look is needed.

Should a Look be provided for a Closet Club member by, for instance, a vendor or stylist, the Look and/or garments may be posted directed to the closet of a member. Such a Look provided in response to a Request for Wardrobe is termed an “Augmented Look.” Alternatively, Looks and garments for inclusion in the closet may be chosen by the closet owner, stylist or other person having such authority granted by the Closet owner. In addition, privacy settings for each Closet may limit access to information retrieved from or received by each Closet.

FIG. 6 is a flowchart that outlines the process for receiving Looks in connection with a request sent to one or more Closet members for a Look or a completion of a Look pursuit to a Request for Wardrobe. A Dispatch of a Request for Wardrobe 100 is sent from one Closet member to selected members of the Closet Club. In connection to a response to the Request 102 being received, a determination of whether the response is desired or liked is made at decision box 104. Desired Looks are Stored 106 in a requestor's closet. A determination is made at 108 as to whether more responses to the Request for Wardrobe are available. If yes, the next response is processed as described above. If not the process pauses 110 until the next response is received. An electronic signal may be dispatched via a communication network as described herein to prompt storage of a desired Look.

The various embodiments may also be used in connection with various resources available via network 201 (e.g., the Internet, Intranet or other communications network) as illustrated in FIG. 7 which shows communication system 200. One or more servers such as Server 101 may hold wardrobe information for each Closet A, B and C. The wardrobe information may comprise text, data, still images, and images to be displayed as moving images. Devices 204 (a mobile device such as a mobile phone), 206 (a laptop, notebook or tablet computer) or 212 (a personal computer or terminal (smart or dummy)) may be used to access the information held in server 101 through network 201.

Typical mobile devices 204 suitable for use with the various embodiments will have in common the components illustrated in FIG. 7. For example, an exemplary mobile device 204 may include a processor 204A coupled to internal memory 204B, and a display 204C. Additionally, the mobile device 204 may have an antenna 204D for sending and receiving electromagnetic signals.

The embodiments described above may also be implemented on any of a variety of other devices, such as a device 206. Such a device 206 typically includes a processor 206A coupled to volatile memory 206B and optionally, memory 206C. Device 206 may also include a transceiver 206D coupled to processor 206A that is configured to communicate with network 201.

The embodiments described above may be implemented with any of a variety of general purpose computers or server devices, such as the server 101 illustrated in FIG. Z. Server 101 typically includes a processor 101A coupled to volatile memory 101B and a large capacity nonvolatile memory, such as a disk drive 101C.

The processors in the various devices 204, 206, and 212 may be any programmable microprocessor, microcomputer or multiple processor chip or chips that can be configured by software instructions (applications) to perform a variety of functions, including the functions of the various embodiments described herein.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, and logical blocks/modules, described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program'product.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A communication device comprising:
a transmitter;
a receiver and a processor, said transmitter being capable of sending a request to augment a Look to one or more members of a network, said receiver being capable of receiving an augmented Look from one or more members of said network in response to said request to augment said Look and;
sending a signal to store said augmented Look in connection with a preference.

2. A computer program product comprising:
non-transitory computer readable media, for use by a processor, including instructions to allow selected users to accomplish a task consisting of viewing, suggesting or editing wardrobes comprising a Look; said computer readable media further including instructions to allow the scheduling of a Look according to calendar event.

3. A computer program product as recited in claim 2 wherein suggesting or editing wardrobes is accomplished in connection with purchasing items selected from among sellers.

4. A computer program product as recited in claim 2 wherein said computer program product is provided for access by users over the Internet.

5. A computer program product as recited in claim 2 wherein said computer readable media additionally includes instructions for permitting selected users for viewing, purchasing, suggesting and editing wardrobes of other users.

6. A computer program product as recited in claim 2 wherein said computer readable media further includes instructions for permitting a user to categorize wardrobe items consisting of categories according to Looks, Color, Designer, Garment and a combination thereof.

7. A computer program product as recited in claim 4 wherein said computer readable media further includes instructions for permitting a user to categorize/catalog wardrobe items consisting of categories according to Looks, Color, Designer, Garment and a combination thereof.

8. A computer program product as recited in claim 4 wherein said computer readable media includes instructions for permitting the sharing of statistical information concerning cataloged wardrobe items used in connection with the computer program product.

9. A computer program product as recited in claim 4 wherein said computer readable media includes instructions for activating a timer indicative of use of selected functions of the computer program product on behalf of a selected person.

10. A computer program product comprising:
non-transitory computer readable media, for use by a processor, including instructions for generating a three-dimensional image of modeling items from a Look on a modeled subject according to scaled physical dimensions of the subject.

11. A computer program product as recited in claim 10 wherein said three-dimensional image is accomplished in connection with generating said image using virtual reality modeling methods.

12. A method for completing a wardrobe Look comprising:
causing an electronic image of a Look comprising selected wardrobe items to be sent to entities connected through a computer network;
sending a request to said entities to augment said Look;
receiving one or more augmented Looks from one or more said entities in response to said request;
causing selected augmented Looks to be stored in an electronic memory in connection with a preference.

13. The method as recited in claim 12 wherein said augmented Look is received in connection with receiving purchase information for selected items comprising the augmented Look.

14. The method as recited in claim 12 wherein said electronic image of a Look sent to said entities is accompanied by information consisting of preference information.

15. The method recited in claim 12 wherein said entities are selected from the group consisting of vendors, stylists, members of a network, and combinations thereof.

16. The method of claim 12 wherein said electronic image of a Look is selected from the group consisting of shoes, apparel, jewelry, hats, scarves and combinations thereof.

17. The method of claim 12 wherein wardrobe Looks are stored for each entity of the entities connected through the computer network.

18. The method of claim 17 wherein said wardrobe Looks may be accessed by an access device selected from the group consisting of a mobile device, a personal computer, a dummy terminal, a computer terminal or a combination thereof.

19. The method of claim 18 wherein said wardrobe Looks are stored remotely from said access device,

20. The method of claim 12 wherein said network is selected from the group consisting of the Internet, and intranet, a wireless communications network or a combination thereof.
